(19) United States
(12) Patent Application Publication
(10) Pub. No.: US 2004/0119724 A1
(43) Pub. Date: Jun. 24, 2004

(54) Digital prepress masking tools

(75) Inventor: Wayne Hawksworth, Heatherton Village (GB)

Correspondence Address: GARDNER CARTON & DOUGLAS LLP, ATTN: PATENT DOCKET DEPT., 191 N. WACKER DRIVE, SUITE 3700, CHICAGO, IL, 60606, US

(73) Assignee: Imagelinx International Ltd., Kirkby-in-Ashfield (GB)

(21) Appl. No.: 10/324,898

(22) Filed: Dec. 20, 2002

(51) Int. Cl. G09G 5/00

(52) U.S. Cl. 345/626

(57) ABSTRACT

Digital prepress masking tools are described, including suggestions for how to implement the tools within a native artwork production software environment. The invention allows for the prepress work of extracting high quality masks to be accomplished without conversion to a proprietary file format, and with improved efficiency. The masking tools allow stored path data to be extracted from placed images and automatically generated according to certain user specified criteria.

### FIELD OF THE INVENTION

This invention generally relates to reproduction of digital artwork. More specifically, the invention relates to software tools for prepress masking of digital artwork.

### BACKGROUND OF THE INVENTION

It is conventional for graphic designers and artists today to create and modify digital artwork in an artwork production environment, such as Adobe Illustrator™ or Macromedia Freehand™. Depending on the environment, the term “digital artwork” may refer to files in many different formats, to database objects, or to some other kind of digital information used to describe text or graphic objects.

There is often a need for two or more separate pieces of digital artwork to be combined into a single piece of digital artwork. For example, an artist may desire for an Adobe Photoshop™ graphic to be included in an Adobe Illustrator™ file. Combining, splicing, or otherwise adding a first piece of digital artwork to a second piece of digital artwork often requires a mask to be applied.

Digital artwork (for example, PostScript format files) often includes a plurality of objects. In a vector-based artwork production environment, objects are defined using a logically connected group of points (or vectors). A logically connected group of points is called a “path” in the PostScript programming language. Masks include open, closed, or compound paths that “mask out” (or block) from view everything but the path defined by the mask itself. For example, when a mask is a closed path, the mask can block from view all objects in the digital artwork outside the closed path.

Conventional methods for applying masks to digital artwork in an artwork production environment are inadequate when high accuracy is required. For example, placed raster images in Adobe Illustrator™ often require highly accurate masks to be applied before trapping or clipping. (As is known to those of ordinary skill in the art, trapping is a digital prepress processing technique for alleviating misalignment during printing.) Commercial prepress software packages, such as Esko-Graphics Barco™ or Artwork Systems Artpro™ are currently available for applying masks to finished artwork. However, the use of such commercial software packages for prepress processing, including the application of color masks, has distinct disadvantages.

Some disadvantages to the use of such commercial software packages for prepress work include the need for file format conversions. The file format of artwork submitted for prepress work is usually different from the file format used by prepress software packages. Finished artwork is usually produced using an artwork production software package, such as Adobe Illustrator™ or Macromedia Freehand™, and must be converted from the file format used by the artwork production software into the file format for the prepress software package before prepress processing can be completed. File conversion errors occasionally result.

Other disadvantages of file conversion include an inability of artists to make even minor changes to artwork already submitted for prepress processing. Thus, artwork usually goes through a long approval process before being submitted for prepress processing. Changes after submission may be costly or impossible. A minor change to a small aspect of artwork submitted for prepress processing may require a large amount of additional work to correct. For example, if a company wishes to make a slight alteration to a text object, the prepress processing might have to be entirely redone. Jobs are often submitted for prepress processing in batch mode so that a single correction to a mask placed in the digital artwork cannot be made without reprocessing of the entire job.

Disadvantageously, when prepress processing is done in batch, a server is often used. Often, when servers are used in prepress processing, all masks applied to a piece of digital artwork are processed (or reprocessed) before transfer back from the server. If an error is found by a user within the native artwork production environment, the piece of digital artwork must be resubmitted and reprocessed. Thus, such conventional systems suffer from many of the disadvantages described above (including, for example, the need for file conversions), and may present additional disadvantages in terms of time needed for transfer of large files back and forth through a network, or cost, for example, of purchasing a server and network hardware.

An additional disadvantage to the use of such proprietary file formats and software packages is that prepress software packages require extensive training. Hence, additional company resources (beyond those necessary for simply creating artwork) are required for artwork to be prepared for printing. A smaller company might be unable to afford printing of high quality artwork for advertisements or product packaging simply because prepress processing is unaffordable.

There is, therefore, a need for an efficient prepress tool for extracting accurate, high quality masks to digital artwork within a native artwork production environment.

### SUMMARY OF THE INVENTION

The present invention meets the foregoing need by providing digital prepress masking tools designed to function within a native artwork production environment. Native artwork production environments include any software packages or applications that can be used to create vector-based digital artwork. In an embodiment, the present invention has been implemented within Adobe Illustrator™. The present invention allows for the prepress work of applying high quality masks to be accomplished without conversion to a proprietary file format, and with improved efficiency. The masking tool allows for masks to be automatically extracted from placed objects according to user specified criteria.

In accordance with the method and system of the present invention, a digital file comprising finished artwork intended for printing is masked within the same software package or application in which it is created (i.e., within the “native” artwork production environment). Masks may be applied to any placed raster object included in the digital artwork without converting the digital artwork into a second format. The invention also allows for a prepress operator to see masks that have been applied within the digital artwork immediately.

Using the method and system of the present invention, it is possible for an artist to extract masks themselves, removing the need for separate prepress processing of artwork before printing, and allowing for revisions or updates to previously finished artwork to be made more easily than with conventional methods for prepress processing of artwork. In an embodiment, files are not saved in a non-native format or converted to a proprietary software system, and there is no need for files to be reconverted after prepress processing before being viewed. Furthermore, because the method and system of the present invention may be implemented within a native artwork production environment, the resources required for adequate training in the application of masks to artwork are substantially fewer.

According to the method and system of the present invention, after digital artwork has been approved by a client, the invention is applied in a native artwork production environment, eliminating the need for a conversion of the digital artwork into a different format, or for transfer back and forth from a remote server. After the method of the present invention has been carried out, the digital artwork can be submitted for print processing, for example, as a postscript file. The digital artwork submitted is usually received by a Raster Image Processor (RIP) for screen ruling, dot gain analysis, and angle, dot shape or structure assignment. The digital artwork might then be sent to an output device, such as a plate or film setter. For gravure printing, the bitmap data is either sent to a digital engraving machine or data is output to film, and engraved on a cylinder. No prepress processing outside the native artwork production environment is needed.

In an embodiment, the invention has been implemented as a plug-in for use with Adobe Illustrator™. However, as will be understood by those of ordinary skill in the art, the method and system of the present invention are susceptible to implementation in a plurality of different artwork production environments, for example, in an environment in which the prepress tools are implemented without reference to a previously developed Application Programming Interface (API) or other libraries of software tools. The invention should be understood to include such alternative embodiments since the masking tool described herein might be implemented by one of ordinary skill in the art in any such alternative embodiments.

In many conventional artwork production software packages, digital artwork is output as a PostScript language file. Hence, much of the terminology used to describe how masks are implemented in the present invention is common to the PostScript programming language. An excellent reference, including a detailed description of some of the PostScript language terms and concepts used in the present application (for example, paths, Bezier paths, and current transformation matrices) is publicly available at http://partners.adobe.com/asn/developer/technotes/postscript.html in the third edition of the PostScript Language Reference manual. The digital prepress masking tools of the present invention are implemented, in an embodiment, as a plug-in for Adobe Illustrator™, a commercial artwork production software package that has conventionally produced PostScript format output files. However, as described above, other programming languages or scripts might also be used to implement the digital prepress tools of the present invention.

In an embodiment, the digital prepress tool of the present invention allows a user to extract a clipping path from a placed Encapsulated PostScript (EPS), Desktop Color Separation (DCS) format file, or Tagged Image Format File (TIFF), and to apply extracted data as masks to vector art objects within a design, including selected, placed images.

In accordance with the present invention, a “path” is a graphic object specified by logically connecting at least two points. The path may be straight or curved as specified, for example, by designating the points as knots in a Bezier curve. Paths may be “closed” so that it has a well-defined interior portion, or “open”. Paths may also be “stroked” so that the logically connected points in the path are physically connected by lines, or, in cases where the paths are closed, “filled” so that the interior portion of the path has a well-defined color. A closed path may be stroked, filled, both, or neither. In addition, closed paths also have the property of being “clockwise” or “anticlockwise”, depending on whether the logical connections between the points of the path are traversed in a clockwise or an anticlockwise direction. This last property is sometimes needed for use in determining whether a particular point within a piece of artwork lies inside or outside a closed path.

In accordance with an embodiment of the invention implemented within Adobe Illustrator™, “clipping paths” define regions of a page that may be affected by a painting operator, should a paint operator be applied. Marks falling inside an area defined by the closed subpaths of the clipping path are painted; marks falling outside are not painted. “Placed” art, images, or objects are embedded or linked files, for example, in the EPS, DCS, or TIFF format. Placed art is associated with a reference file.

In an embodiment, the method and system of the present invention include transformation matrices (“matrix” singular, “matrices” plural). A matrix is an array of numbers, usually arranged into columns and rows, which summarizes numerical elements, for example, variables in a system of linear equations. Matrices are well suited for describing how two-dimensional shapes transform in a plane since translations, rotations, reflections, expansions (or contractions), shears, and any combination thereof are describable using a system of three linear equations with three variables, or a “transformation matrix” of three columns and three rows.

In Adobe Illustrator™, a “Current Transformation Matrix” (CTM) is used to track changes to the shape of placed art. Each pair of coordinates (x, y) used to represent a point in the placed art is transformed into a new pair of coordinates (x′, y′) for a transformed (or reshaped) object using a system of three linear equations in three variables: (The third coordinate and variable are always constant since translations are limited to the two-dimensional plane of the artwork.)

x′=a·x+c·y+tₓ

y′=b·x+d·y+t_{y}

And the variables a, b, c, d, tₓ, and t_{y} are represented more compactly as a transformation matrix:

$$( \begin{matrix}a & c & 0 \\ b & d & 0 \\ {t}_{x} & {t}_{y} & 1\end{matrix} )$$

Each time a transformation is applied to a placed object, the matrix corresponding to the transformation (T) is multiplied by the CTM for the placed object (or “concatenated with the CTM”) in order to produce a new CTM (CTM′):

CTM′=T+CTM

CTM is then redefined as CTM′. This multiplication and redefinition may be repeated, so that the CTM of a placed object is the concatenation of all transformations applied to the object since the object was first placed in the artwork, reflecting all previous transformations that have been applied to the placed object.

According to an embodiment of the present invention, each object within a file of digital artwork is masked individually. After a user has created an object from a vector path, for example, in Adobe Photoshop™, the object is placed (as a DCS, EPS, or TIFF format file) in a piece of digital artwork, for example, in an Adobe Illustrator™ document. The user then activates the masking tool, which extracts the vector path, and applies a mask. After the tool has been activated, the placed object is contained within the newly extracted path as a mask. The user is then able to further manipulate the mask as needed. For purposes of description, the terms “placed object” and “placed image” shall be used interchangeably herein.

### BRIEF DESCRIPTION OF THE DRAWINGS

The foregoing and other objects, advantages, and features of the present invention will be apparent from the following detailed description and the accompanying drawings, in which:

FIG. 1A shows a screenshot of a toolbar and an object selected for path extraction, in accordance with an embodiment of the present invention;

FIG. 1B shows a screenshot of a toolbar and an extracted path and a clipping mask, in accordance with an embodiment of the present invention;

FIG. 1C shows a screenshot of a toolbar and a selected extracted path, in accordance with an embodiment of the present invention;

FIG. 2 shows a flowchart of an overall method for applying masks, in accordance with an embodiment of the present invention;

FIG. 3 shows a flowchart of a method for extracting a path, in accordance with an embodiment of the present invention;

FIG. 4 shows a flowchart of a method for creating a path, in accordance with an embodiment of the present invention;

FIG. 5 shows a flowchart of a method for extracting path data from a file, in accordance with an embodiment of the present invention;

FIG. 6 shows a flowchart of a method for extracting image scaling data from a file, in accordance with an embodiment of the present invention;

FIG. 7 shows a flowchart of a method for applying an image transformation matrix, in accordance with an embodiment of the present invention;

FIG. 8 shows a flowchart of a method for path creation based on user selection, in accordance with an embodiment of the present invention;

FIG. 9 shows a flowchart of a method for user selected path creation using path data and a transformation matrix, in accordance with an embodiment of the present invention;

FIG. 10 shows a flowchart of a method for processing subpath length in accordance with an embodiment of the present invention; and

FIG. 11 shows a flowchart of a method for processing Bezier knot records, in accordance with an embodiment of the present invention.

### DETAILED DESCRIPTION OF THE INVENTION

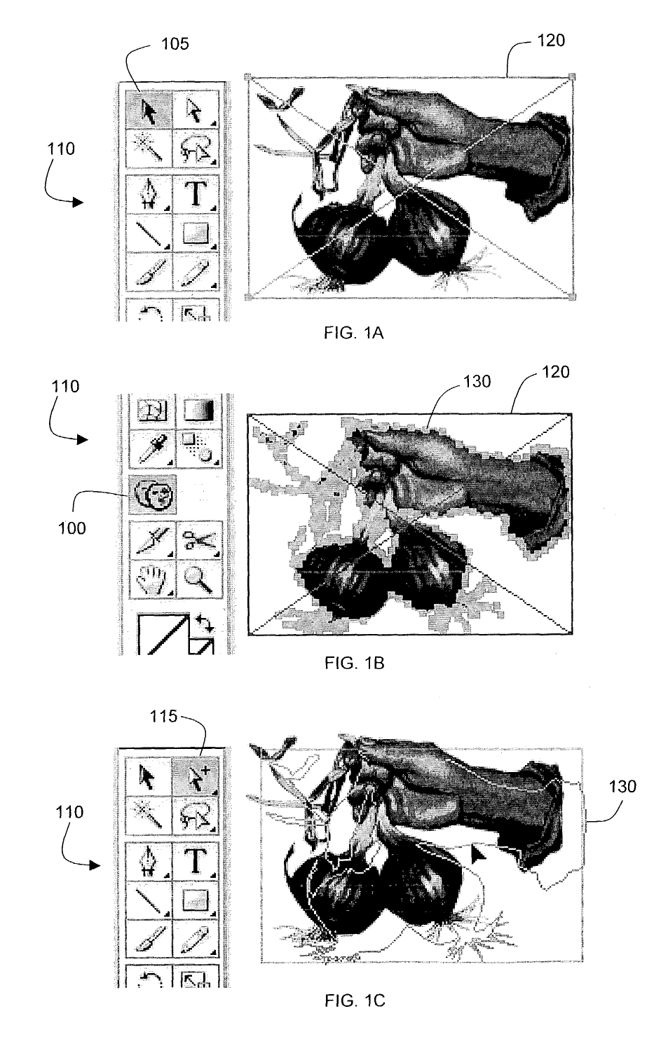

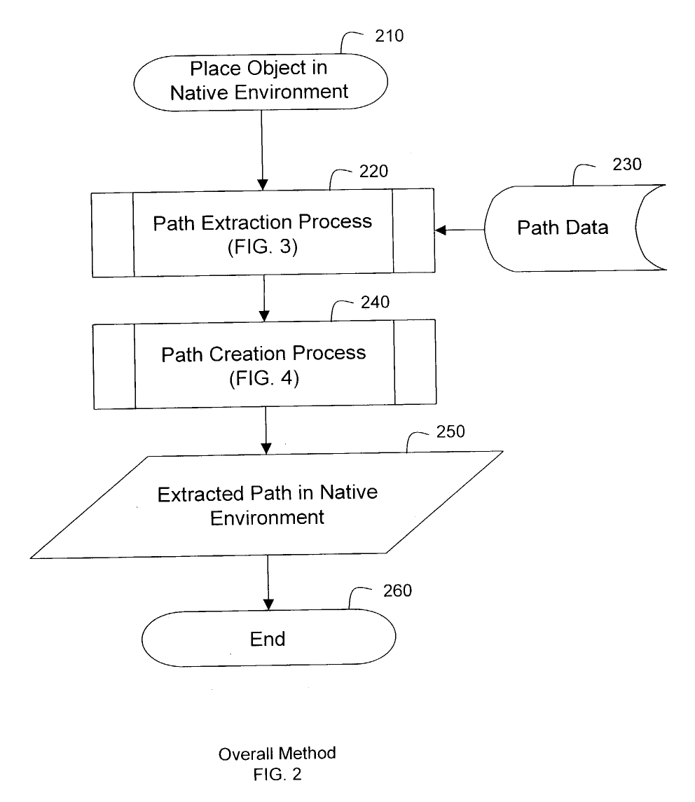

As described above, the digital prepress masking tool may optionally be implemented as a plug-in for Adobe Illustrator™. FIGS. 1A-C show screenshots of how a mask is applied to a placed object using a masking tool in a toolbar, in accordance with an embodiment of the present invention. Several illustrations of how a digital prepress masking tool 100 is used, for example, by a graphic artist or prepress operator, are provided in connection with FIG. 1 before the detailed description of an embodiment of the method and system of the present invention are shown in connection with the flowcharts of FIGS. 2-11.

Before using the digital prepress masking tool 100, digital artwork, for example, in the format of an Adobe Illustrator™ file, is loaded into an artwork production environment. As shown in FIG. 1A, an object 120 such as an EPS, DCS, or TIFF file placed within the piece of digital artwork is selected, for example, with a direct selection tool 105 in the toolbar 110. Next, as shown in FIG. 1B, the digital prepress masking tool 100 (located, in an embodiment, in the toolbar 110) is activated so that a path stored within the selected object is automatically extracted, creating a clipping mask 130. FIG. 1C shows how (after use of the digital prepress masking tool 100) the clipping mask 130 or object 120 may be selected either independently or as a group using the direct selection tool 105 or group selection tool 115, respectively.

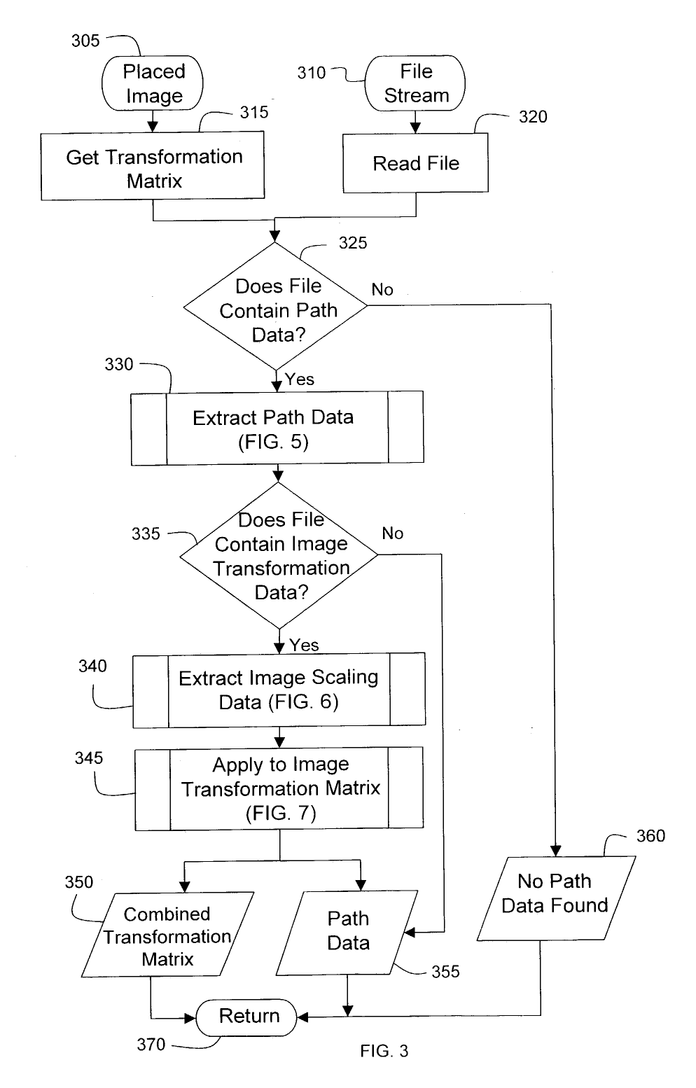

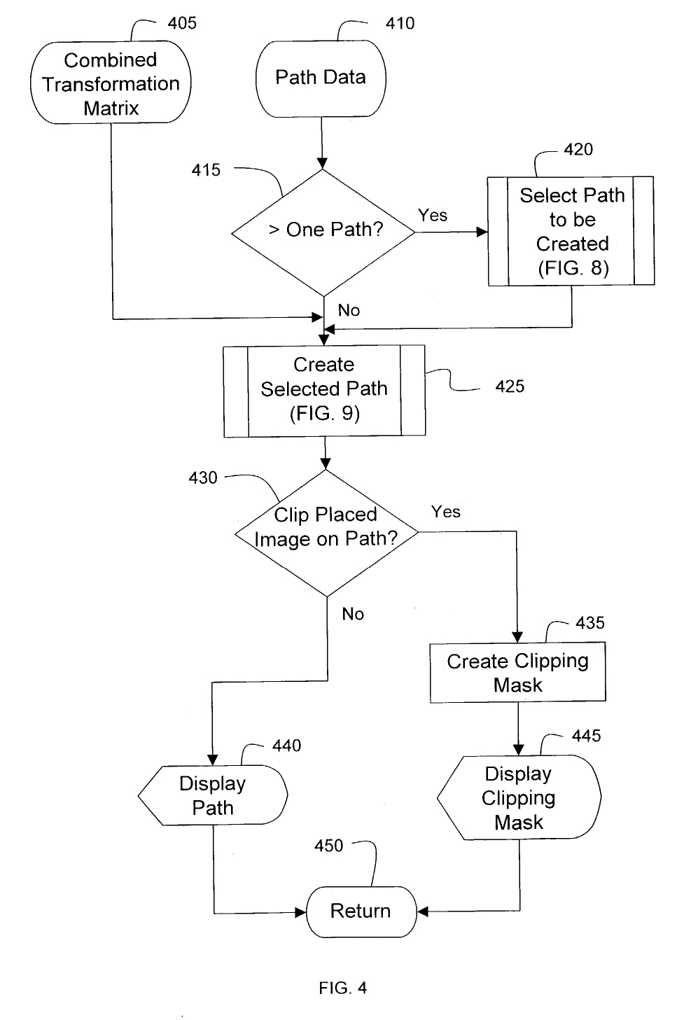

The method and system of the present invention are carried out, in an embodiment, according to a process shown in the flowcharts of FIGS. 2-11. Referring to FIG. 2, there is shown a flowchart of an overall method for applying a digital prepress masking tool. The method includes sub-processes for path extraction 220 and path creation 240, each of which is shown in another figure (FIG. 3 and FIG. 4, respectively). The overall method begins in step 210, when an object of digital artwork (for example, an image in a digital file of EPS, DCS, or TIFF format), is placed in a native artwork production environment such as Adobe Illustrator™. After the object has been placed in step 210, a path extraction process 220 is used, as described below in connection with FIG. 3, to acquire path information, which must be embedded in the placed object. (The number of embedded paths in a placed object varies between zero and many.) In an embodiment of the present invention, a user is prompted during step 220 to specify what (if any) paths are to be extracted. The user can also specify whether an extracted path is to be created as a compound path object, or to be used as a clipping path for the placed object. After the extraction process in step 220, extracted path data 230 is also stored, as indicated in FIG. 2.

A path creation process 240 follows the path extraction process in the embodiment of the overall method of the present invention shown in FIG. 2. Based on the specifications made by the user in step 220, the extracted path data 230 is created in the native artwork production environment as an extracted path 250, and displayed for further processing. In an embodiment, one or more transformations applied to a placed object before path extraction in step 220 are reapplied to created compound path objects after step 240. The overall method is finished in step 260, after the extracted path is displayed in the native artwork production environment.

An important advantage of the present invention is that the overall method, as shown in FIG. 2, is carried out entirely within a native artwork production environment. Conventionally, path extraction and creation has been done in non-native prepress environments, such as Esko-Graphics™ or Artpro™. Non-native environments, however, require conversion of the digital artwork into a different digital format, and thus introduce a plurality of disadvantages, as described in the BACKGROUND OF THE INVENTION section above.

In an embodiment, the path extraction sub-process (step 220 in FIG. 2) comprises a process for transferring path data from an external file (for example, an EPS, DCS, or TIFF file) into memory within the native artwork production environment. A flowchart of a method for path extraction in FIG. 3. The path extraction process takes a placed image 305 and a file stream 310 as input and produces path data 355 (if any) and a combined transformation matrix 350 as output.

The file stream 310 may include transformation data in addition to path data in some embodiments of the invention. For example, transformation data may be located after path data in the file stream. The transformation data included in a file stream 310 is also applied to the placed image so that the placed image is appropriately scaled, rotated, and so on. However, if transformation data cannot be read from the file stream 310, the transformation matrix obtained from the placed image 305 is still applied, as described below.

A transformation matrix is obtained from the placed image 305 in step 315 of FIG. 3. The transformation may reflect any of a plurality of translations, rotations, reflections, shears, and scales (see description in the SUMMARY OF THE INVENTION section above). The placed image 305 has an associated current transformation matrix (CTM), which stores the history of all transformations applied to the placed image.

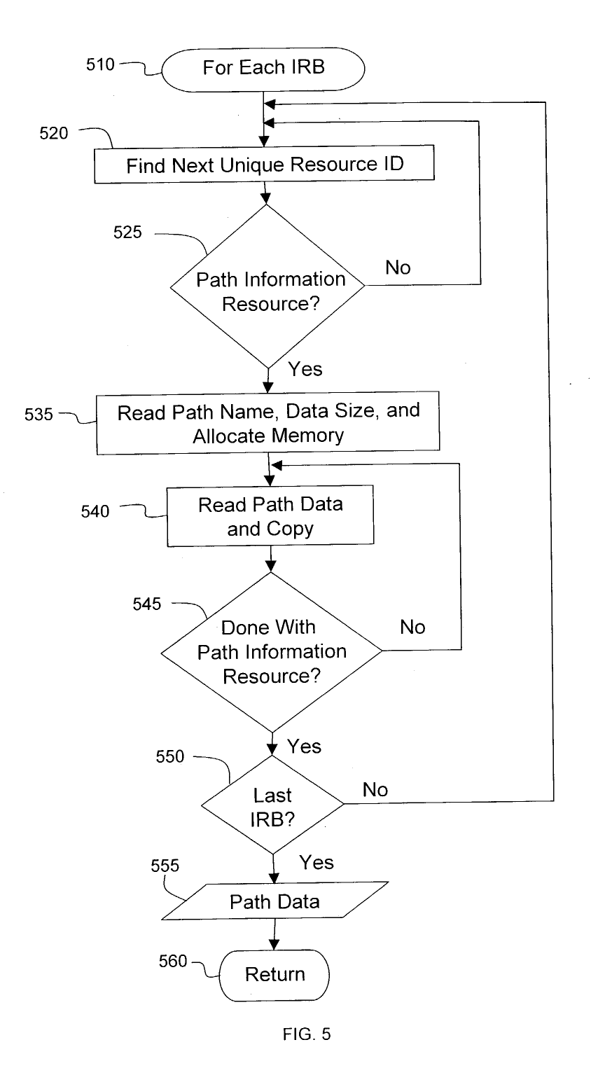

Either immediately before or immediately after step 315, the file stream 310 is read in step 320. The raw data obtained in step 320 does not usually reflect any transformations, but the file stream 310 can have data for one or more paths in addition to data needed for rendering the image itself (for example, a vector object or raster image). The file stream 310 may also have no path data. In an embodiment, the present invention checks, in step 325, to see if path data is included in the file stream 310. If no path data is included (step 360) then the method of path extraction, as shown in FIG. 3, is finished; in step 370, control returns to the overall method of the present invention (an embodiment of which is shown in FIG. 2). If path data is found in step 325, then in step 330, the path data is extracted using an extract path data sub-process 330, shown, in an embodiment, in FIG. 5.

In an embodiment of the present invention in which placed images are Adobe Photoshop™ files, the extract path data sub-process 330 takes one Image Resource Block (IRB) 510 at a time as input, and produces path data 555 therefrom. Referring to FIG. 5, for each IRB 510 found in a file associated with a placed image 305, the IRB 510 is searched, in step 520, for unique resource identification (ID). If a path information resource is found (in step 525), then the method proceeds; if a path information resource is not found, then the next unique resource ID in the file is checked, and the method repeats until all unique resource IDs have been checked in step 525.

Unique resource IDs are preceded, in an embodiment of the present invention, by a signature block and are followed by a Pascal string, which includes a name used for a resource when the resource was saved. Size data, and the actual resource data itself follows the Pascal string. In step 535 of FIG. 5, the path name and size are read, and memory within the native artwork production environment is allocated to accommodate the Resource data comprises a series of 26 byte path point records. After memory allocation in step 535, the path data is read and copied into an output data structure for the native artwork production environment. As shown by step 545, this step repeats until all of the paths in a path information resource are exhausted. If the path information resource has been exhausted, in step 550, the next IRB is selected and the method of FIG. 5 repeats until all TRBs have been processed according to the method of steps 510-545. Each set of path data 555 created for each IRB using the method of FIG. 5 includes a name for the resource, a number of path point records in the resource, a record length (in an embodiment, 26 bytes), and path point records. In an embodiment, memory is allocated dynamically as needed. In step 560, the extract path data sub-process 330 of FIG. 5 returns to the path extraction sub-process 220 of FIG. 3.

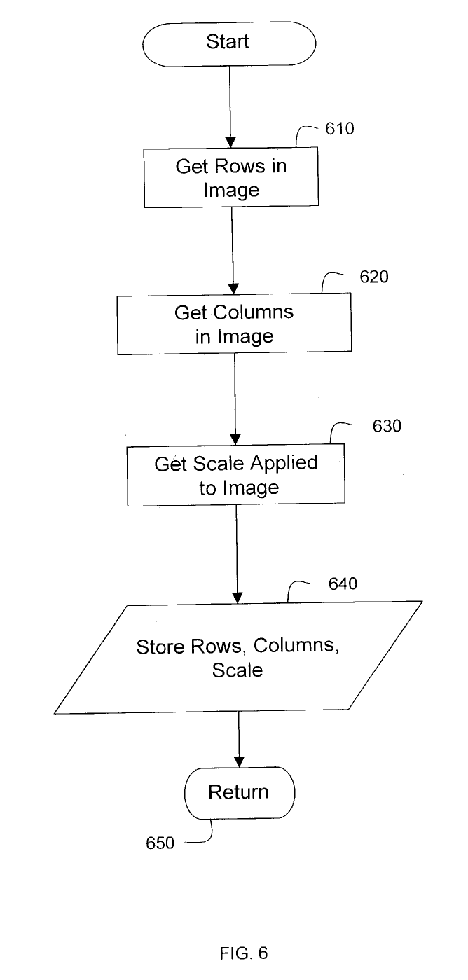

The path extraction sub-process 220 of FIG. 3 continues by checking, in step 335, whether the file stream 310 includes image transformation data. If not, then the path data extracted (in the sub-process of step 330) is stored alone in step 355. If the file stream 310 does contain image transformation data, then in step 340, image scaling data is extracted using a sub-process shown, in an embodiment, in FIG. 6.

Extraction of image scaling data, as shown in FIG. 6, requires few steps. First, the number of rows in an image are obtained in step 610, followed by the number of columns in step 620. In step 630, the scale applied to the image is obtained. Finally, each of these values is stored in memory in step 640, and in step 650 control is returned to the path extraction sub-process of FIG. 3. In an embodiment in which a placed image or object is an EPS or DCS format file, Postscript commands that include row, column, and scaling information are embedded in the files, and are obtained according to the method of FIG. 6.

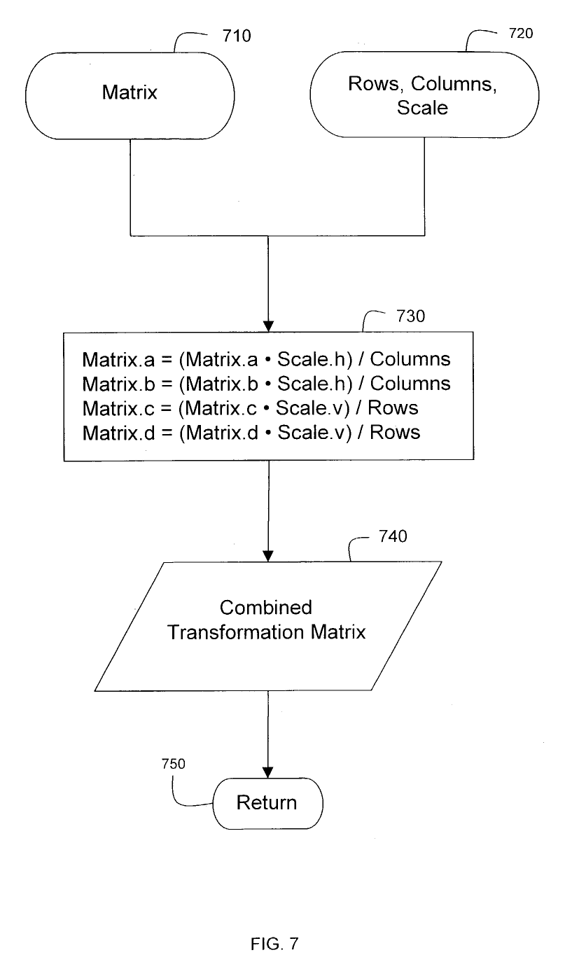

After image scaling data 640 has been stored in memory, the path extraction sub-process of FIG. 3 continues with the apply to image transformation matrix sub-process of step 345, which is shown, in an embodiment, in FIG. 7. Turning to FIG. 7, there is shown how, in an embodiment, the image scaling data 640 extracted and stored (as shown in FIG. 6) and a matrix (found in step 315 of FIG. 3) are taken as input, and a combined transformation matrix 740 is produced as output. The combined transformation matrix 740 is produced in step 730 by scalar multiplication of each of the transformation matrix elements a, b, c, and d (see SUMMARY OF THE INVENTION section above), and division by the number of columns and rows of the placed image. In step 750, control returns to the path extraction sub-process of FIG. 3.

Having executed the steps of the process and sub-processes shown in FIG. 3, a combined transformation matrix 350 and path data 355 are produced as output of the path extraction sub-process 220 shown in FIG. 3. In step 370, control returns to the steps overall method shown in FIG. 2.

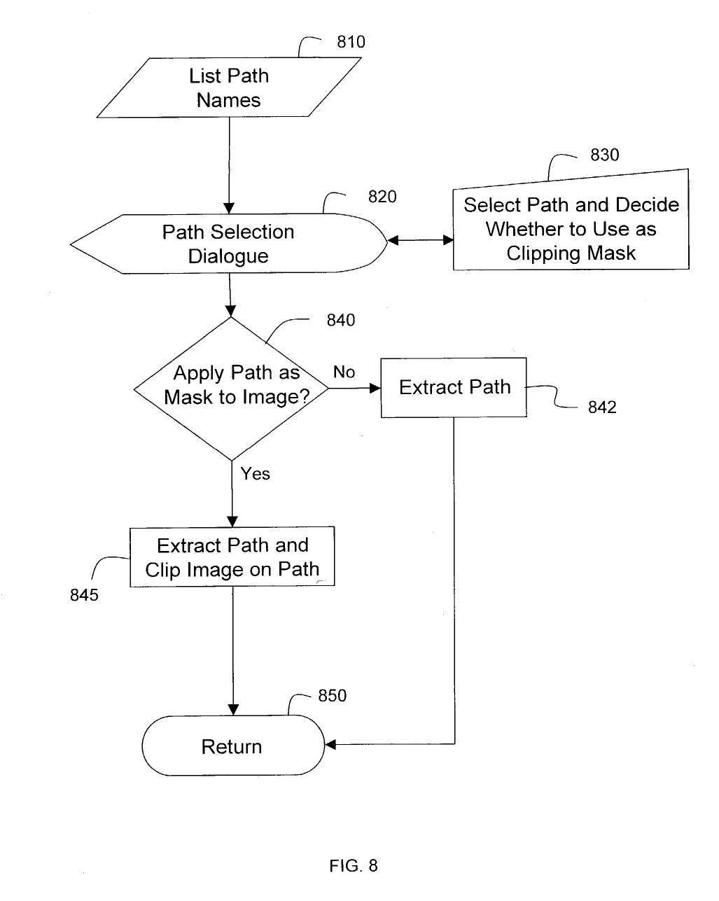

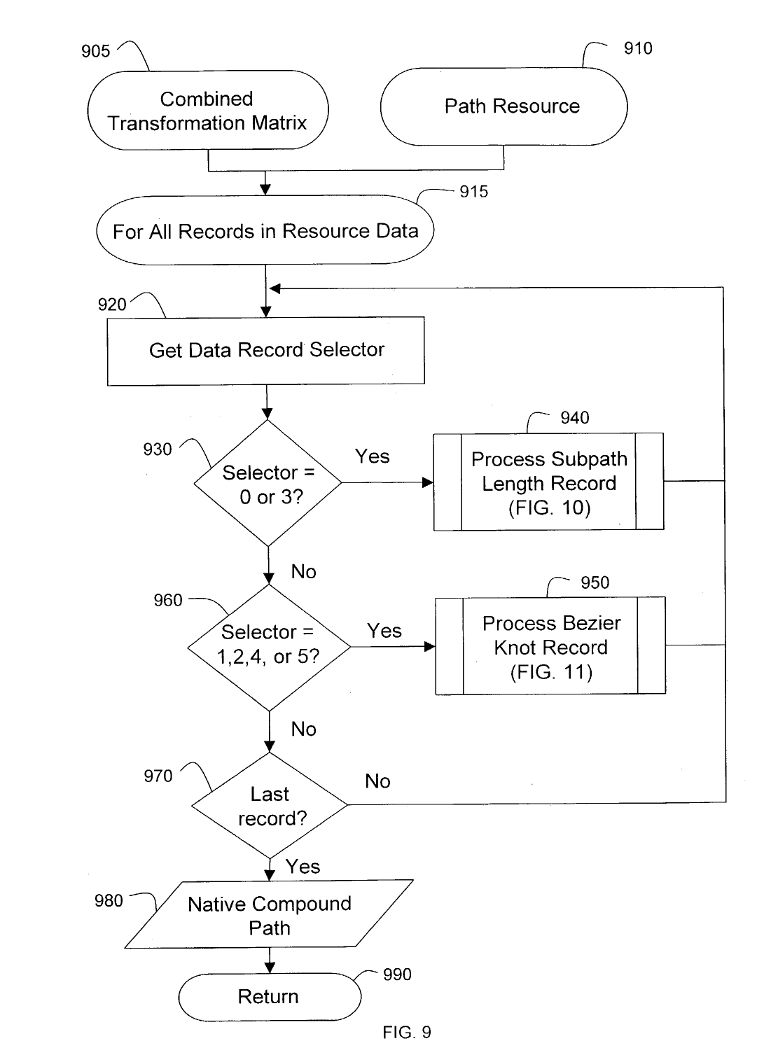

The next step of the overall method of the present invention is part of the path creation sub-process 240 shown, in an embodiment, in FIG. 4. Referring to FIG. 4, the path creation sub-process 240 takes a combined transformation matrix 405 and path data 410 (obtained in steps 350 and 355 of FIG. 3) as input, and displays either a path 440 or a clipping mask 445 as output before returning to the steps of the overall method of FIG. 2 in step 450. Step 415 of the path creation sub-process 240 includes checking of path data to determine whether none, one, or more than one path is present in the path data 410. If the path data does contain more than one path, then the method continues, in step 420, with the select path sub-process shown, in an embodiment, as FIG. 8. If there is not more than one path, then the one path that is included in the image data is selected, and the extract path data sub-process continues with step 425, which includes the create selected path sub-process shown, in an embodiment, in FIG. 9. The select path sub-process called in step 420 shall be reviewed briefly before describing the create selected path sub-process called in step 425.

An embodiment of the select path sub-process is shown in FIG. 8. The select path sub-process comprises a dialogue 820 showing a list of path names 810 generated from the path data 410. Using the dialogue 820, a user selects a single path in step 830, and in the same step specifies whether the selected path is to be applied to the placed image as a clipping path. After the user has provided input to the dialogue in step 820, it is determined in step 840 whether the path is to be applied as a clipping mask to a placed image. If so, then in step 845 the path data included with the image is extracted, and is used to clip the selected placed image, and control returns to the path creation sub-process of FIG. 4 in step 850. If the path is not to be applied as a clipping mask to the placed image, then in step 842 the path data is extracted nonetheless, and in step 850, control returns to the path creation sub-process of FIG. 4.

After a path selection sub-process 420, the method of FIG. 4 continues with a create selected path sub-process 425, an embodiment of which is shown in FIG. 9. A combined transformation matrix 905 and a path resource 910 (obtained in accordance with the methods shown in FIGS. 3, 5, and 7) are provided as input to the create selected path sub-process 425; a native compound path 960, such as an Adobe Illustrator™ compound path is produced as output. As shown in step 915, for all path records found in the path resource data 910, a loop is executed including the steps 920 of obtaining the data record selector, and of processing the record as either a length (step 940) or Bezier knot record (step 950).

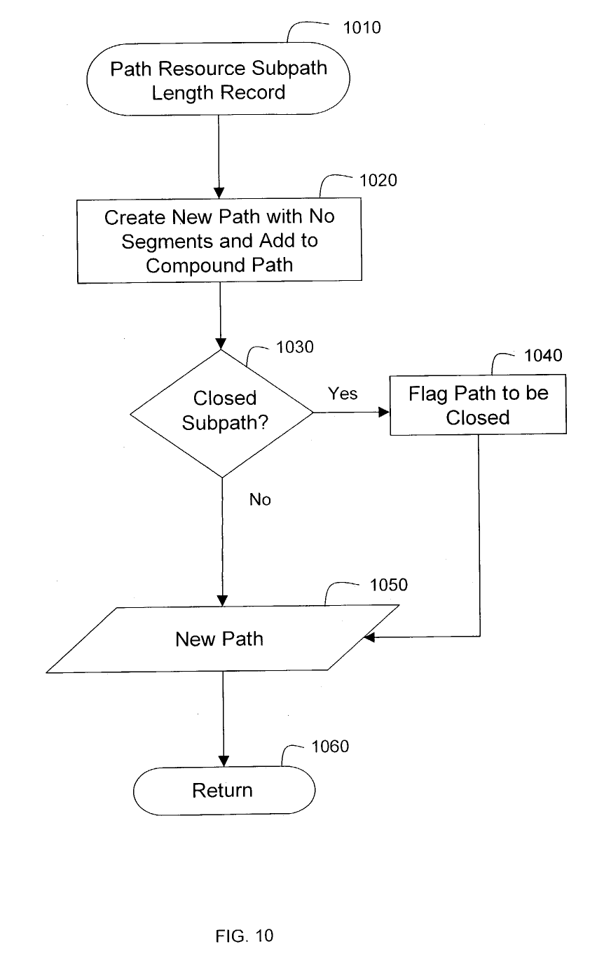

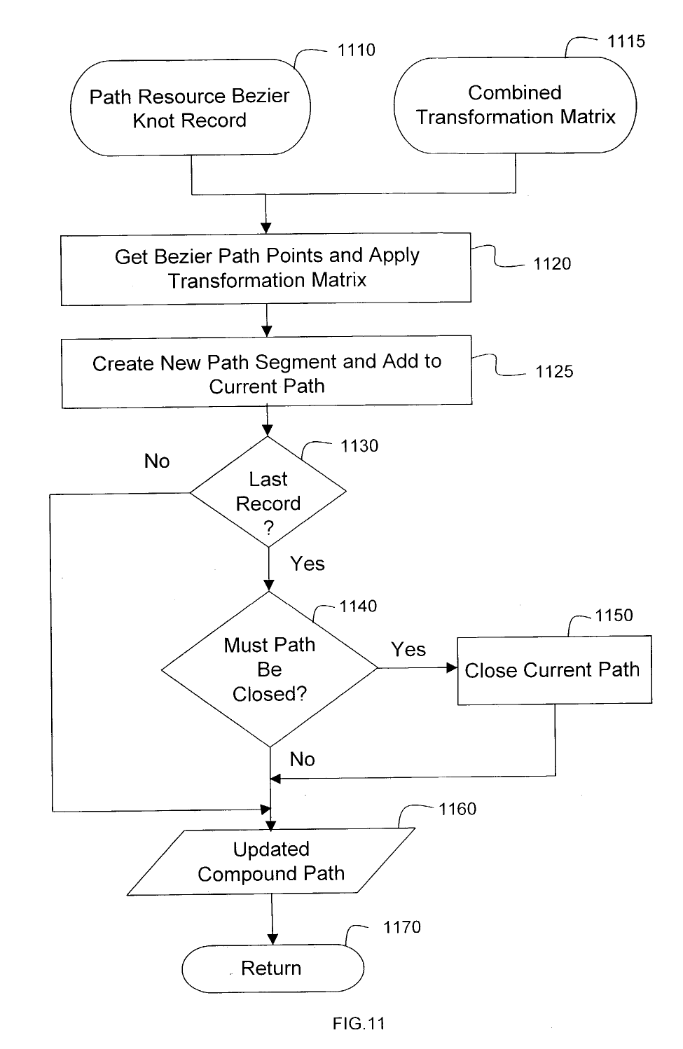

In an embodiment of the present invention in which the placed image is an Adobe Photoshop™ file, data in a path resource 910 includes a series of 26 byte records. The first two bytes of each record is a “selector”, indicating to which type of path a particular record corresponds. Subpath length type records indicate where a new subpath starts and provide the number of Bezier knot records in the subpath in bytes 2 and 3. A selector of 0 indicates that the subpath length record is closed whereas a selector of 3 indicates that the subpath length record is open. Bezier knot type records use the remaining 24 bytes for storing 3 path points as a pair of 32 bit components, vertical component first. Bezier knot type records describing knots of the current subpath follow the subpath length record immediately. FIG. 10 shows an embodiment of a sub-process 940 for handling length type records, and FIG. 11 shows an embodiment of a sub-process 950 for handling Bezier knot type records.

Turning to FIG. 10, there is shown how an input length type record from a path resource 1010 is processed (after being identified in step 930 of FIG. 9). In step 1020, a new path (in an embodiment, an Adobe Illustrator™ path) is created with no (zero) segments, and is added to the current compound path. As shown in step 1030, the method of FIG. 10 also uses the information stored in the selector for the record as to whether the path was open (selector=3) or closed (selector=0). If the selector was zero, then the path is flagged to be closed in step 1040, and in step 1050 the new path is created. Control returns to the create selected path sub-process 425 in step 1050.

In FIG. 11, Bezier knot type records in the path resource are processed, in accordance with an embodiment of the method of the present invention. The path resource Bezier knot type record 1110 (identified in step 960 of FIG. 9) and the combined transformation matrix 115 are used to produce an updated compound path 1160 through the steps of the method of FIG. 11. In a first step 1120 of the method, Bezier path points are obtained from the record, and transformations are applied. Each Bezier knot record comprises three path points as a pair of 32 bit components, vertical component first. The two components are signed, fixed point numbers with 8 bits before the binary point and 24 bits after. Points are expressed relative to image height and widths.

In an embodiment of the present invention in which the placed image is an Adobe Photoshop™ file and the native artwork production environment is Adobe Illustrator™, three transformations might be necessary. First, since the origin for the coordinate system is at the top-left of a page in Adobe Photoshop™ and at the bottom-left of the page in Adobe Illustrator™, a translation is needed:

x′=y

y′=1.0−x

(The points x′, y′ are still expressed relative to the image height and width.)

In addition, a scaling transformation is applied before any user transformations:

x″=width·y′

y″=height·x′

Finally, a user applied transformation matrix is applied:

x′=a·x+c·y+tₓ

y′=b·x+d·y+t_{y}

Thus, Bezier path segments from a placed image are translated directly into path segments within the native artwork production environment, and are created in step 1125 with the values calculated in step 1120. As is known to those of ordinary skill in the art, the first point in each knot record is a control point for the Bezier segment preceding the knot; the second point is an anchor point for that knot; and the third point is the control point for the Bezier segment leaving the knot. Linked knots correspond to non-corner segments and unlinked knots represent corner segments.

As shown in step 1130, the method of FIG. 11 is repeated for each of the Bezier type knot records in the path resource 1110. When the last record has been processed, if the path was designated a closed path by the selector for the resource (in FIG. 9), then the current path is closed in step 1150. The end result is the updated compound path 1160. Control returns to the method of FIG. 9 in step 1170.

As shown in step 970 of FIG. 9, the create selected path sub-process 425 also repeats for each of the records in the path resource 910, producing a native compound path 960 after the last record has been processed. Control returns to the path creation sub-process of FIG. 4 in step 990.

In the remaining steps of the path creation sub-process 240 shown, in an embodiment, in FIG. 4, the native compound path 960 is used either to display a path 440 or to create a clipping mask 445 depending on what the user has specified, as determined in step 430. Control returns to the overall method shown in FIG. 2 in step 450.

Returning to FIG. 2, there is shown how, after the path creation sub-process 240 has been executed, an extracted path (or a clipping mask 445 created from the extracted path) is displayed in step 250, bringing the overall method of the present invention, as shown in FIG. 2, to an end.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of applying a mask to an object in a native artwork production environment, the method comprising the steps of:
placing the object in the native artwork production environment;
within the native artwork production environment, extracting stored path data from the object; and
within the native artwork production environment, creating a path from the stored path data extracted from the object.

2. The method of claim 1, wherein, in the step of extracting path data from the object, a transformation matrix is extracted from the object along with the path data.

3. The method of claim 2, further comprising the step of:
applying the transformation matrix to the path.

4. The method of claim 1, wherein, in the step of extracting path data from the object, path data for more than one path is extracted.

5. The method of claim 1, wherein, in the step of creating a path from the path data extracted from the object, a clipping mask is created.

6. The method of claim 1, wherein, in the step of extracting path data from the object, the path data includes image resource blocks.

7. The method of claim 1, wherein, in the step of extracting path data from the object, the path data includes subpath length records.

8. The method of claim 1, wherein, in the step of extracting path data from the object, the path data includes Bezier knot records.

9. A method of applying a mask to an object in a native artwork production environment, the method comprising the steps of:
placing the object in the native artwork production environment;
within the native artwork production environment, extracting path data and a transformation matrix from the object;
within the native artwork production environment, creating a path from the path data extracted from the object; and
within the native artwork production environment, applying the transformation matrix to the path.

10. The method of claim 9, wherein, in the step of extracting path data from the object, path data for more than one path is extracted.

11. The method of claim 9, wherein, in the step of creating a path from the path data extracted from the object, a clipping mask is created.

12. The method of claim 9, wherein, in the step of extracting path data from the object, the path data includes image resource blocks.

13. The method of claim 9, wherein, in the step of extracting path data from the object, the path data includes subpath length records.

14. The method of claim 9, wherein, in the step of extracting path data from the object, the path data includes Bezier knot records.

15. A system for applying a mask to an object in a native artwork production environment, the system comprising:
means for placing the object in the native artwork production environment;
means for extracting path data from the object within the native artwork production environment; and
means for creating a path from the path data extracted from the object within the native artwork production environment.

16. The system of claim 15, wherein the means for extracting path data from the object also extracts a transformation matrix from the object.

17. The system of claim 16, further comprising:
means for applying the transformation matrix to the path.

18. The system of claim 15, wherein the means for extracting path data extracts path data for more than one path.

19. The system of claim 15, further comprising:
means for creating a clipping mask from the path data; and
means for displaying the clipping mask in the native artwork production environment.

20. The system of claim 15, wherein the path data includes image resource blocks.

21. The system of claim 15, wherein the path data includes subpath length records.

22. The system of claim 15, wherein the path data includes Bezier knot records.

23. A digital artwork masking system for use in a native artwork production environment, the system comprising:
at least one software tool for applying a mask to at least part of a placed object, which extracts path data from the placed object so that the masked object is ready for print processing after use of the digital artwork masking system.

24. The digital artwork masking system of claim 23, wherein the path data extracted includes a combined transformation matrix that is used in applying the mask to the at least part of a placed object.

25. The digital artwork masking system of claim 23, wherein the path data extracted includes data for more than one path.

26. The digital artwork masking system of claim 23, wherein the mask applied is a clipping mask.

27. The digital artwork masking system of claim 23, wherein the path data extracted includes at least one image resource block.

28. The digital artwork masking system of claim 23, wherein the path data includes subpath length records.

29. The digital artwork masking system of claim 23, wherein the path data includes Bezier knot records.
